(19) United States
(12) Patent Application Publication
(10) Pub. No.: US 2023/0249448 A1
(43) Pub. Date: Aug. 10, 2023

(54) THERMOPLASTIC COMPOSITE ELEMENT WITH IMPROVED RESISTANCE TO DELAMINATION

(71) Applicants: Jan VERHAEGHE, Haasdonk (BE); Johny HERMANS, Knokke-Heist (BE); Koen DE ROEVE, Berlare (BE)

(72) Inventors: Jan VERHAEGHE, Haasdonk (BE); Uwe BUELTJER, Ludwigshafen-am-Rhein (DE)

(21) Appl. No.: 18/015,416

(22) PCT Filed: Jul. 12, 2021
(86) PCT No.: PCT/IB2021/056252

§ 371 Date: Jan. 10, 2023

(30) Foreign Application Priority Data
Jul. 10, 2020 (BE) BE2020/5518

(51) Int. Cl. B32B 37/06; B32B 3/12; B32B 5/02; B32B 5/18; B32B 37/10; B32B 5/26; B32B 5/24

(52) U.S. Cl. CPC B32B 37/06; B32B 3/12; B32B 5/02; B32B 5/18; B32B 5/26; B32B 5/245; B32B 37/10; B32B 2255/02; B32B 2255/26; B32B 2260/021; B32B 2260/046; B32B 2262/06; B32B 2262/10; B32B 2262/101; B32B 2262/103; B32B 2262/105; B32B 2262/106; B32B 2262/0253; B32B 2262/0261; B32B 2262/0269; B32B 2262/0276; B32B 2266/08; B32B 2266/0264; B32B 2307/516; B32B 2307/748; B32B 2309/02; B32B 2309/12; B32B 2311/30; B32B 2313/04; B32B 2315/02; B32B 2315/085; B32B 2317/10; B32B 2323/04; B32B 2367/00; B32B 2377/00; B32B 2439/00; B32B 2605/00

(57) ABSTRACT

The invention provides a method of manufacturing a composite element having improved resistance to delamination includes a first thermoplastic polymer layer and a second thermoplastic polymer layer. A boundary surface of the first thermoplastic polymer layer is chemically crosslinked with a boundary surface of the thermoplastic polymer layer. The composition for the crosslinking includes a thermoplastic polymer and a monomer or oligomer having at least two reactive functional groups selected for reactivity with the functional groups on the thermoplastic polymer boundary surfaces. A composite element can be obtained by the process. It is further provided that the composite element may be used as a wall in a transport vehicle, a wind turbine, a storage area, or a packaging container.

### TECHNICAL FIELD

The invention relates to a method for fabricating a composite element with improved resistance to delamination. The invention also relates to the composite element and uses thereof. The invention is situated in the domain of the plastic composites, more in particular plastic composite panels. The invention is especially interesting for applications in which a combination of strength and lightweight are important.

### BACKGROUND

A composite element is a material which is composed of several components with different physical or chemical characteristics which, in combination, provide an element with characteristics which are different from the individual components. Composite elements are used for replacing traditional materials such as glass, steel, aluminium, and wood. Examples of composite elements are fibres combined with plastic. The combination of fibres with a plastic material, can provide a material which stays lightweight and is still very strong and stiff. Another example is the combination of a layer of plastic material with a layer of foamed plastic for forming layered plastic elements. They have a good thermal insulation and are lightweight.

Several techniques are well-known for combining plastic materials such as laminating, welding, gluing, or stitching. Working with different layers is often aimed at reinforcing the composite element in three directions, length-width-height.

When laminating, the contact surfaces of the layers to join are heated and pressed together, wherein the plasticized materials fuse together. When cooling down, the materials harden, and they are joined physically.

Welding is the process of joining materials by using pressure and/or heat, wherein the material is deposited onto the joining location in a liquid state, wherein continuity arises between the parts to join.

Lamination and welding are joining techniques consuming quite a lot of energy. They are preferably used for joining two of the same materials. The heating of materials is not appropriate for temperature-sensitive materials. There is a risk of carbonizing materials.

When gluing, a material is used which is sticking or adhering to the materials to join. When gluing, the materials to join do not have to be heated. However, panels made of a foamed core between two fibre-reinforced plastic layers, which are glued to the foamed core, have delamination problems at mechanical load. In aircraft construction, glued panels are not accepted.

In stitching, materials are fastened by means of an in-and-out motion with wire or rope. EP1506083 for example discloses a 3D reinforced composite element consisting of a sandwich of a core material inserted between two fibre-reinforced layers, wherein the layers are secured by tufting an essentially continuous fibre-reinforced material through the different layers, followed by an impregnation of the laminate with a liquid plastic, and the curing of the plastic by cooling it down. It is not obvious to penetrate panels by means of a needle and thread for securing them with stitches. The process of obtaining liquid plastic, requires heating above the melting temperature of the plastic. This requires a lot of energy. The plastic which had been melted, is applied as an outer layer on top of a layer of fibre-reinforced plastic. At a high degree of reinforcement, and consequently a large presence of fibres, the fibres can constitute a physical barrier impeding the penetration of the molten plastic.

US 4,092,202 discloses a method for joining foils. First, a reaction product is made by reacting a hydroxy functional polyether or polyester with polyisocyanates or polyisothiocyanates. The reaction product contains free -NCO or -NCS groups and can react with H-acid compounds in a foil. The reaction product has an average molecular weight of 500-10,000. The reaction product is applied at a maximum of 140° C. In example 1, a polyester foil is joined with a polyethylene foil for forming a thin laminate structure. No solution is offered for the problem of delamination in thick laminate structures, such as laminates comprising a panel.

UK 1384694 discloses a method for fabricating laminates which are still mouldable for obtaining the final product. The laminate comprises a reformable polymer material (skin layer) and at least a layer of a partially reacted polymerisate. The stiff end product can be used as a panel. No solution is offered to enable the panel to be used in applications with both a static and dynamic load, such as in transport applications.

In WO9636676, a multi-layered composite material is disclosed, in which a foam layer with open cells is impregnated with an isocyanate having at least 1 NCO group, for filling the cells, after which the foam layer on the surfaces is reinforced with a layer of reinforced material, the layers are pressed together to impregnate the layers with isocyanate and subsequently, under pressure and at elevated temperature, the isocyanate forms a trimer and isocyanurate compounds make the composite material stiff. No solution is offered to enable the panel to be used in applications with both a static and dynamic load, such as in transport applications.

In US 5,362,529, a polyester-polyamide laminate is disclosed which has been obtained by coextrusion. No solution is offered for the problem of delamination in a laminate structure made of panels.

Consequently, there is a need for further alternatives and improvements.

The present invention aims to offer a solution for one or more of the above-mentioned problems. The invention aims to offer a process which is energy efficient.

The process should be reliable. The invention aims to offer a process which is economically relevant, deployable at large scale. The invention aims to offer a composite element with improved resistance to delamination. Preferably, the improved resistance to delamination is obtained without losing strength or lightweight.

### SUMMARY OF THE INVENTION

Thereto, the invention offers a method for the fabrication of a composite element with improved resistance to delamination, according to claim 1. The invention also offers a composite element with improved resistance to delamination, according to claim 18. Furthermore, the invention provides uses for a composite element according to an embodiment of the invention. Further preferred embodiments have been described in the dependent claims.

The invention is based on the provision of a flexible thermoplastic layer between two or more layers of thermoplastic materials, which are the same or different. The way of joining and building up the structure leads to an improved resistance to delamination of the multi-layered structure. This is applied advantageously in composite elements in the form of a panel, especially at multi-layered structures comprising several panels. Composite panels constructed in this way can be used advantageously in applications where they are subject to both static and dynamic loads, such as in transport applications.

### DESCRIPTION OF THE FIGURES

FIG. 1 shows a schematic illustration of a panel according to a preferred embodiment of the invention.

FIG. 2 shows a schematic illustration of an alternative preferred embodiment of a composite element according to the invention.

### DETAILED DESCRIPTION OF THE INVENTION

Unless otherwise specified, all terms used in the description of the invention, including technical and scientific terms, shall have the meaning as they are generally understood by the worker in the technical field the present invention relates to. Furthermore, definitions of the terms have been included for a better understanding of the description of the present invention.

As used here, the following terms shall have the following meaning: “A”, “an” and “the”, as used here, refer to both the singular and the plural form unless clearly understood differently in the context. For example, “a compartment” refers to one or more than one compartment.

“Approximately” as used here, that refers to a measurable value such as a parameter, a quantity, a period or moment, etc., is meant to include variations of +/-20% or less, preferably +/-10% or less, more preferably +/-5% or less, still more preferably +/-1% or less, and even still more preferably +/-0.1% or less of the cited value, as far as such variations are appropriate for realizing the invention that is described. It will however be clear that the value to with the term “approximately” relates, will also be described specifically. The terms “include”, “including” and “included”, as used here, are synonym with “comprise”, “comprising” and “comprises” and are inclusive or open terms that indicate the presence of what follows e.g. a component, and that do not exclude the presence of additional, non-said components, characteristics, elements, members, steps, that are well-known from or described in the state of the art.

The citation of numeric intervals by means of end points includes all integers and fractions included within that interval, including these end points.

The invention provides a solution to the problem of improving delamination resistance in multi-layered composites. The improved resistance is preferably both with a static and dynamic load of a composite element according to an embodiment of the invention.

More in particular, the invention provides in a first aspect in a method for the fabrication of a composite element with improved resistance to delamination, the composite element comprising a first thermoplastic polymer layer a) and a second thermoplastic polymer layer b), in which a boundary surface of the first thermoplastic polymer layer a) is chemically crosslinked to a boundary surface of the second thermoplastic polymer layer (b), comprising the steps:
providing a first thermoplastic polymer layer a) comprising a boundary surface with at least one functional group rₐ),
providing a second thermoplastic polymer layer b), said layer b) comprising a boundary surface with at least one functional group f_{b}, equal to or different from said functional group rₐ,
applying a composition c) on the boundary surface of the first and/or second thermoplastic polymer layer, the composition comprising
   c1) a thermoplastic polymer with at least one functional group r_{c}, equal to or different from said functional group rₐ) and/or r_{b}), and
   c2) a monomer or oligomer with at least two reactive functional groups r_{d1}), r_{d2}), preferably r_{d1}) = r_{d2}), wherein r_{d1}) and r_{d2}) are selected for reactivity with the functional groups rₐ), r_{b}) and r_{c}),
reacting said at least two functional groups r_{d1}), r_{d2}) of the monomer or the oligomer with said functional groups rₐ), r_{b}), r_{c}), thereby crosslinking the boundary surface of the first layer a), the boundary surface of the second layer b) and the thermoplastic polymer c1).

Said method has the advantage that chemical compounds ensure that different layers are connected to each other. The chemical compounds have a covalent nature. The crosslinked layers ensure an improved resistance to delamination.

The monomer/oligomer is not a building block for the polymer with thermoplastic and elastomer properties, but is attached to the polymer. This has the effect that a minimum molecular weight is present in the central polymer part.

The term thermoplastic polymer, as used herein, is a generic term for plastics; preferably polyurethanes, polyamides, or polyesters; who are solid at 25° C. and soften upon heating. The thermoplastics have the advantage that they are recyclable.

Preferably, the thermoplastic polymer is a thermoplastic elastomer.

The term elastomer, as used herein, indicates polymers with rubbery characteristics. An elastomer is elastic under moderate tension. An elastomer has a relatively high tensile strength and memory, so that, when removing the tension, the elastomer returns to its original dimensions which are practically comparable to its original dimensions.

Thermoplastic elastomers (TPE) refer to materials having both thermoplastic and elastomer characteristics. The elastomer characteristic ensures a good dynamic loading capacity of the composite element obtained according to the method. The hardness of the thermoplastic elastomers is preferably situated between 20 Shore A and 80 Shore A.

More preferably, the thermoplastic elastomer is a thermoplastic polyurethane elastomer. A polyurethane is composed of a molecule having several isocyanate (—N═C═O) functional groups and a molecule having several alcoholic groups (—OH), called polyol. The selection of polyisocyanate and polyol give a polyurethane elastomer characteristics or not. The selection of a thermoplastic elastomer of the polyurethane type contributes to an improved dynamic loading capacity. The attachment of the thermoplastic polyurethane elastomer to the boundary surfaces of two thermoplastic materials with short compounds (monomer/oligomer) into a 3-dimensional large mesh net, further contributes to the elastomer characteristics of the intermediate layer. This improves the dynamic load capacity.

The thermoplastic polyurethane elastomer can be an aromatic or aliphatic polyurethane elastomer. The functional groups, with which the reactive monomer/oligomer can react, can be hydroxyl and/or carboxyl groups. The thermoplastic polyurethane can be produced with a chain extender. Examples of chain extenders are amines or alcohols with at least two functional groups.

Appropriate diisocyanates as starting material are toluene diisocyanate (TDI), diphenylmethane diisocyanate (MDI) 1,5-naphthalene diisocyanate (NDI), tetramethyl xylene diisocyanate (TMXDI), isophorone diisocyanate (IPDI), 4,4′-bis-methylene cyclohexane diisocyanate (HMDI).

Preferably, the production of a composite element is realized in an environment with a low humidity. Preferably, relative humidity is below 50%, more preferably below 40%, most preferably below 30% at 25° C. More preferably, a moisture absorber is added to the composition c).

Preferably, said first thermoplastic polymer layer a) is fibre-reinforced. This is advantageous for providing a strong layer.

More preferably, the fibre reinforcement is provided by fibres selected from: glass fibres, aramid fibres, carbon fibres, basalt fibres, polyethylene fibres, polyester fibres, polyamide fibres, ceramic fibres, steel fibres, vegetable fibres, or combinations thereof.

Said second thermoplastic polymer layer b) is preferably selected from a foamed thermoplastic polymer layer, a fibre-reinforced thermoplastic polymer layer, a foamed and fibre-reinforced thermoplastic polymer layer, a thermoplastic polymer layer with a honeycomb structure, or combinations.

When using a foam layer, the foam can have an open or closed cell structure. A closed cell structure is preferred.

The foamed thermoplastic polymer layer preferably has a density of at least 50 kg/m³, more preferably at least 100 kg/m³, still more preferably at least 200 kg/m³, most preferably at least 300 kg/m³.

The second thermoplastic polymer layer b) is preferably a foamed layer. Suitable materials are a foamed thermoplastic polyurethane, foamed thermoplastic polyamide or a foamed thermoplastic polyester. The advantage of a foamed layer is the lightweight. More preferably, the second thermoplastic polymer layer b) is a thermoplastic polyester. Most preferably, the second thermoplastic polymer layer b) is recycled thermoplastic polyester. The foamed layer b) is preferably a polyethylene terephthalate (PET) foam layer or a polyethylene furanoate (PEF) foam layer.

In an alternative preferred embodiment of the invention, the second thermoplastic polymer layer b) is a fibre-reinforced layer. The presence of fibres has the advantage that it offers reinforcement.

In another alternative preferred embodiment of the invention, the second thermoplastic polymer layer b) is a layer with a honeycomb structure. The effect of the use of a material with a honeycomb structure is that it provides a light and strong material layer.

More preferably, one or both layers a) or b) is a fibre-reinforced thermoplastic polymer layer. Most preferably, both layers a) and b) are fibre-reinforced thermoplastic polymer layers.

In another preferred embodiment of the invention, the first thermoplastic polymer layer a) is a fibre-reinforced thermoplastic layer and the second thermoplastic polymer layer b) is a foamed thermoplastic layer, whether or not fibre-reinforced.

Preferably c1) the thermoplastic polymer and c2) the reactive monomer or oligomer are brought together less than 60 hours prior to the fabrication of the composite element. More preferably, c1) and c2) are brought together less than 48, 36, 24, 12, 6, 3, 2, 1, or 0.5 hours prior to the fabrication of the composite element. A fresh preparation is advantageous for a good reactivity and crosslinking with the thermoplastic polymer layers a) en b).

Preferably, before, during or after the application of said composition c), heating to a temperature below the melting temperature of the thermoplastic layer a) and the melting temperature of the thermoplastic layer b) is performed. Preferably, the heating temperature is situated between 30° C. and 120° C., more preferably between 35° C. and 100° C., most preferably between 40° C. and 80° C. The use of a heating temperature below the melting temperatures, has the advantage that the risk of burning is low. Less energy is used compared to a heating above the melting temperature for the same period of time.

In another preferred embodiment, crosslinking is realized at room temperature of 20-25° C. This has the advantage that no heat supply is required.

Composition c) is preferably applied in a liquid state. This is a comfortable way of applying a composition. This method can easily be used at large scale.

More preferably, c) the liquid composition has a viscosity situated between 100 and 3000 mPa.s, more preferably between 500 and 2500 mPa.s, still more preferably between 1000 and 2300 mPa.s, most preferably between 1500 and 2200 mPa.s, measured at 20° C.

The viscosity is preferably chosen for allowing spreading the composition in a thin layer. At the same time, the composition is preferably not so liquid that the composition penetrates much in a foamed material and material is not available for adhesion to the boundary surface or flows from the surface when manipulating a layer.

If desired, thickeners can be added to increase the viscosity. An example of an appropriate thickener is bentonite or starch.

The liquid composition c) is preferably substantially free of water. The term ‘substantially free of water’ means a water content below 5%. Preferably, the water content is below 1%, more preferably below 0.5%, most preferably below 0.1%. The water content of the liquid composition c) can be determined with a Karl Fisher water titration. The presence of water is kept low for avoiding the formation of foam.

The liquid composition c) is preferably a solvent-based composition. A solvent means a dissolving means which is not water. A solvent appropriate for use in the present invention is methyl ethyl ketone (MEK).

Preferably, the liquid composition c) comprises less than 30% of solvent. More preferably, less than 20%, still more preferably less than 10%, most preferably less than 5% of solvent is used. The amount of solvent is expressed in volume of solvent with respect to the total volume of solvent, monomer/oligomer, and thermoplastic polymer. This ensures a good proximity of the c1) and c2) components.

In an alternative preferred embodiment, composition c) is applied in the form of a powder. Preferably, the components c1) and c2) are mixed well before they are used in a method according to an embodiment of the invention.

In an alternative preferred embodiment, composition c) is applied in the form of a film. A film can for example be obtained as follows: mixing cl and c2) both in a solid state; spreading the powder mixture followed by heating the powder mixture; forming a liquid or sintered layer; cooling down the layer with the formation of a film.

Preferably, in a method according to the invention, furthermore at least 0.5 bar (50000 Pascal) and at most 5 bar (500000 Pascal) of pressure is applied, following the application of composition c). The use of pressure is advantageous for a good contact between the different materials. This is advantageous for a good binding of the materials.

The monomer or oligomer is preferably an epoxide, an aziridine, a carbodiimide, a polyisocyanate, a polyamine, a polyol, an ethylene vinyl acetate (EVA), of a combination thereof.

The term oligomer, as used herein, refers to a chemical compound composed of at least two units or monomers. The number of units is preferably lower than 10, more preferably lower than 5, most preferably lower than 4.

The ratio of monomer or oligomer with respect to thermoplastic polyurethane elastomer is preferably between 95:1 and 1:95, more preferably between 80:20 and 20:80, expressed in weight of monomer or oligomer with respect to the weight of thermoplastic polyurethane elastomer (w/w).

Preferably, a method according to an embodiment of the invention is implemented as follows:
said composition c) is applied onto said boundary surface of the first thermoplastic polymer layer a),
said composition c) is applied onto said boundary surface of the second thermoplastic polymer layer b),
both boundary surfaces treated with composition c) are oriented towards each other and layer a) and b) are brought together.

Preferably, layer a) and b) are pressed together.

Layers a) and b) are preferably brought together in the longitudinal direction for forming a layered composite element. This can be achieved by superimposing for example two panels a) and b), after treatment with composition c).

In an alternative embodiment, layers a) and b) are joined in an extension to each other. When using two panels a) and b), the composition c) forms a seam, after crosslinking and joining.

In an alternative embodiment, the method is used for joining two panels a) and b) in an angle. This can be used for the construction of a container.

An alternative method according to an embodiment of the invention is implemented as follows:
said composition c) is applied onto said boundary surface of the first thermoplastic polymer layer a), and
the second thermoplastic polymer layer b) is applied onto said composition c).

Most preferably, composition c) is applied in the form of a layer onto the boundary surface of a) the first thermoplastic polymer layer, and subsequently, the boundary surface of b) the second thermoplastic polymer layer is applied onto the layer comprising composition c), and pressed.

In still another alternative method according to an embodiment of the invention, said composition c) is applied as follows:
said c2) monomer or oligomer is applied in a liquid form onto the boundary surface of the a) first and b) second thermoplastic polymer layer,
c1) is delivered in the form of a film and is applied between a liquid c2) layer on the boundary surface of the a) first and b) second thermoplastic polymer layer.

Preferably, in a method according to an embodiment of the invention, one or both of said boundary surfaces a) and b) are made dust- and fat-free before composition c) is used. Thereto, a solvent such as acetone or methyl ethyl ketone (MEK) can for example be used. This solvent treatment is advantageous for the activation of the boundary surfaces a) and/or b).

In another preferred embodiment, one or both of boundary surfaces a) and b) are treated with a plasma, before composition c) is used. This surface treatment is advantageous for the activation of the boundary surfaces a) and/or b).

The boundary surface a) and/or b) can be coarsened before composition c) is used.

Preferably, at least one functional group rₐ) and/or r_{b}) is selected from an OH group, an SH group, an NH group, an NH2 group, a carboxyl group.

Preferably, layer a) comprises a polyamide composition, preferably a polyamide composition comprising fibres, preferably glass fibres; most preferably a composition comprising polyamide and (glass) fibres obtained from an impregnation and in situ polymerisation process of caprolactam and (glass) fibres.

Preferably, layer b) comprises a (glass) fibre content of at least 40% in weight, more preferably at least 50% in weight, still more preferably at least 60% in weight, most preferably at least 70% in weight.

A commercially available product which is preferably used in a method according to an embodiment of the invention are Nylon 6 Organosheets of the company Johns Manville.

In a preferred embodiment of a method according to the invention, a polyamide in layer a) is crosslinked to a polyester in layer b) and a c1) thermoplastic polymer from composition c). More preferably, c1) is a thermoplastic polyurethane; most preferably a thermoplastic polyurethane elastomer.

Most preferably, c2) is a diisocyanate or polyisocyanate. This monomer has an excellent reactivity.

Preferably, the composition c) is applied in an amount of 100 g/m² - 1000 g/m². More preferably, the composition c) is applied in an amount of 100 - 500 g/m², still more preferably 150 - 450 g/m², most preferably 200 - 400 g/m². A low material consumption is economically interesting.

In a second aspect, the invention provides a composite element with improved resistance to delamination, the composite element comprising a first thermoplastic polymer layer a) and a second thermoplastic polymer layer b), in which a boundary surface of the first thermoplastic polymer layer a) is chemically crosslinked to a boundary surface of the second thermoplastic polymer layer b), by means of a composition c) comprising a thermoplastic polyurethane elastomer and a monomer or oligomer for crosslinking a), b) and c), obtainable by a process according to an embodiment of the invention.

Said first thermoplastic polymer layer a) is preferably fibre-reinforced. The first thermoplastic polymer layer a) is preferably reinforced by fibres selected from: glass fibres, aramid fibres, carbon fibres, basalt fibres, polyethylene fibres, polyester fibres, polyamide fibres, ceramic fibres, steel fibres, vegetable fibres, or combinations thereof. Fibre reinforcement makes the polymer layer stronger.

Preferably, said second thermoplastic polymer layer b) is selected from a foamed second thermoplastic polymer layer, a fibre-reinforced second thermoplastic polymer layer, a foamed and fibre-reinforced second thermoplastic polymer layer, a thermoplastic polymer layer with a honeycomb structure.

The foamed thermoplastic polymer layer b) is preferably a foamed polyester polymer layer. More preferably, the foamed thermoplastic polymer layer b) is a polyethylene terephthalate (PET) foam layer or a polyethylene furanoate (PEF) foam layer.

The choice of a polyester foam is advantageous for a dynamic load. A polyester foam has a good behaviour at a point load. A PU foam crumbles. A PVC foam is not resistant to heat.

The fibre-reinforced polymer layer a) is preferably provided in the form of a fibre-reinforced polyamide or in the form of a layer with at least one unidirectional laminate (UD).

A composite element according to an embodiment of the invention is preferably a panel. Preferably, both the thermoplastic layer a) and the thermoplastic layer b) are panels. A composite element according to an embodiment of the invention, comprising a thermoplastic layer a) in the form of a panel and a thermoplastic layer b) in the form of a panel, is advantageous because both panels are joined by means of a monomer/polymer mixture forming a middle layer when crosslinking which is flexibly built-in between two panels. The flexibility of the joining layer and the attachment to the surfaces of the two panels, ensures that the composite panel has an improved resistance to delamination. A composite panel according to this embodiment of the invention is better able to withstand both a static and a dynamic load, preventing or delaying delamination. In an alternative embodiment, the thermoplastic layer a) and/or b) is a profile, preferably a U-shaped profile. This embodiment is advantageous for mounting a panel in a way that has improved shock resistance and resistance to delamination.

The adhesion between the first and second thermoplastic layer is preferably at least 0.10 N/mm², more preferably at least 0.20 N/mm², most preferably at least 0.4 N/mm², measured according to DIN 53292 (Testing of sandwiches; Tensile test perpendicular to the faces).

A composite element, preferably a panel, according to an embodiment of the invention preferably has a weight per square metre of at least 4, more preferably at least 8, most preferably at least 12.

A composite element, preferably a panel, according to an embodiment of the invention preferably has a compressive stiffness of at least 5 MPa, more preferably at least 8 MPa, even more preferably at least 10 MPa, most preferably at least 15 MPa.

The E-modulus of a composite element, preferably a panel, according to an embodiment of the invention is preferably at least 10 MPa, more preferably at least 12 MPa, most preferably at least 15 MPa, measured in a four-point bending test.

The deformation of a composite panel according to an embodiment of the invention, is preferably at most 7 mm, more preferably at most 6 mm, even more preferably at most 5 mm, most preferably at most 4 mm, measured at a load of 1 ton per linear metre, measured on a composite panel of 100 mm × 500 mm × 36 mm or 100 mm × 500 mm × 46 mm.

A composite panel according to an embodiment of the invention preferably has a density of 15-20 kg/m² and/or a bending modulus of 3000 MPa-6000 MPa and/or a compression strength of 5-10 MPa and/or a bending strength of 25-50 MPa and/or a deformation of at most 7 mm, measured on a composite panel having dimensions of 100 mm × 500 mm × 36 mm or 100 mm × 500 mm × 46 mm.

A composite panel according to an embodiment of the invention preferably has at least two, more preferably at least three, even more preferably at least four of the properties from the aforementioned list of density, bending modulus, compression strength, bending strength and deformation.

A composite panel according to an embodiment of the invention preferably has a density of 15-20 kg/m², a bending modulus of 3000 MPa-6000 MPa, a compression strength of 5-10 MPa, a bending strength of 25-50 MPa and a deformation of at most 7 mm, measured on a composite panel having dimensions of 100 mm × 500 mm × 36 mm or 100 mm × 500 mm × 46 mm.

In a third aspect, the invention provides a number of uses.

A composite element according to an embodiment of the invention can be used in various applications where replacement of traditional materials is desired.

Preferably, a composite element according to an embodiment of the invention is used as a wall in a transport vehicle, a wind turbine, a storage space, or a packaging container.

The wall of a transport vehicle can be a side wall, floor wall or ceiling wall.

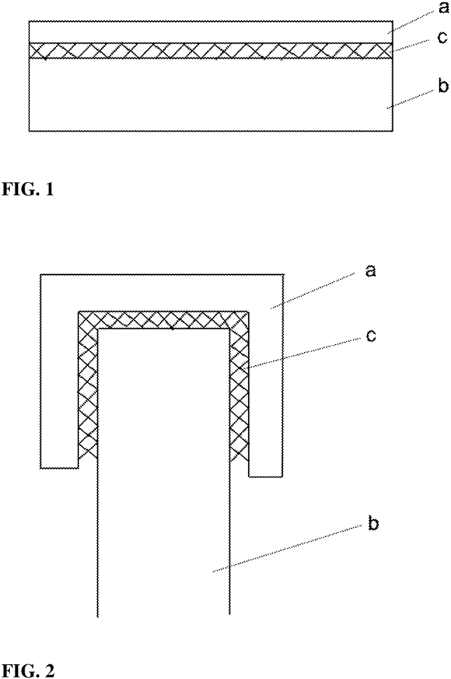

The invention is further illustrated by a number of examples. These are non-limiting. Preferred embodiments of the invention are illustrated in FIGS. 1 to 2.

### EXAMPLES

### Example 1

FIG. 1 is a schematic illustration of a composite element obtained according to a method of the invention. A glass fibre reinforced polyamide panel a was treated with MEK and then coated with a liquid composition c comprising a thermoplastic polyurethane elastomer c1 and a diisocyanate c2. A foamed polyester panel was coated with the same composition. Panel a and b were turned towards each other. The liquid compositions were placed on top of each other. The resulting layered composite element was stored for 24 hours before use. A four-point bending test was performed on the finished product. It was found that there was no delamination, but there was a break in the foam.

Different panel compositions were tested:
Steel 1: glass fibre reinforced PA/c1+c2/320 kg/m³ foam with fibre reinforcement
Steel 2: glass fibre reinforced PA/c1+c2/320 kg/m³ foam without fibre reinforcement
Steel 3: glass fibre reinforced PA/c1+c2/100 kg/m³ foam without fibre reinforcement

The measured E-moduli from the four-point bending test are as follows: 17 MPa for steel 1, 13 MPa for steel 2, 12 MPa for steel 3.

In a comparative test, a composite element was made with thermoplastic polyurethane elastomer in the absence of a reactive monomer/oligomer. The construction was as follows: glass fibre reinforced PA/c1/100 kg/m³ foam. The PA and foam layer were not crosslinked. There was delamination.

### Example 2

FIG. 2 is a schematic illustration of an alternative composite element obtained according to a method of the invention. A U-shaped profile a obtained by injection moulding of a thermoplastic polymer was treated with a liquid composition c comprising a thermoplastic polyurethane elastomer c1 and a diisocyanate c2. A panel of foamed recycled polyester was inserted into the U-shaped profile.

### Example 3

In an additional test, sandwich panels were made as follows. Two organosheet layers of Johns Manville were combined with a foamed thermoplastic panel with density 230 kg/m³ using the joining method according to the invention. The dimensions of the panels were 100×500×36 mm or 100×500×46 mm.

The organosheet layers of Johns Manville consist of a glass fibre reinforced polyamide-6 or nylon-6 matrix. The polyamide is connected to the glass fibres. This material structure offers good mechanical properties. The organosheet layers had a thickness of 3 mm and the fibres had an orientation of 0° (50%) and 90° (50%).

The foamed thermoplastic panel was a foamed PET material with closed cell structures. The thickness of the foamed PET panel was 30 mm or 40 mm.

The foamed thermoplastic panel was connected to the 100×500 mm surfaces with an organosheet layer, forming a sandwich panel. First, MEK was used to activate the molecules on the surface of the organosheet layers and the foamed panel. Then, a mixture of the bonding agent was applied to the organosheet layers and the foamed panel. The bonding agent consisted of a mixture of MDI and a thermoplastic polyurethane (TPU). Preferably a 2:1 MDI-TPU ratio was used. The MDI monomer provided the reaction between the PA-6, PET and the TPU. After reaction, a flexible intermediate layer was incorporated and connected to a PA-6 layer and the foamed PET panel, along both sides of the sandwich panel.

The resulting 100×500×36 mm and 100×500×46 mm sandwich panels were tested for various mechanical parameters. The sandwich panels had an excellent performance. No delamination occurred in bending tests.

The development resulted in sandwich panels with the following mechanical properties, shown in Table 1.

The properties of the sandwich panel are suitable for use in applications with both static and dynamic loads, such as in transport applications. Moreover, the sandwich panels combine strength and lightweight. This is advantageous in transport applications for saving fuel.

TABLE 1

Properties of Agesia sandwich panels

| | | |
|---|---|---|
| Parameter | 100 mm × 500 mm × 36 mm panel | 100 mm × 500 mm × 46 mm panel |
| Density | 18.9 kg/m² | 21.2 kg/m² |
| Bending modulus^{∗} | 5000 MPa | 3400 MPa |
| Compression strength / compression stiffness | 8 MPa | 8 MPa |
| Bending strength | 47 MPa | 28 MPa |
| Deformation at 1 ton/m cont. | 6.70 mm | 4.72 mm |

The flexural modulus was determined according to ISO 14125:1998 - Fibre-reinforced plastic composites - determination of flexural properties.

The sandwich panels were scaled up to larger dimensions, preferably 2440 mm × 300 mm and 2440 mm × 1500 mm with thicknesses of 36 mm or 42 mm, suitable for use as a wall in a transport vehicle, a storage room, or a packaging container.

1-22. (canceled)

23. A method of manufacturing a composite element having improved resistance to delamination, the composite element comprising a first thermoplastic polymer layer and a second thermoplastic polymer layer, in which a boundary surface of the first thermoplastic polymer layer is chemically crosslinked with a boundary surface of the second thermoplastic polymer layer, comprising the steps:
providing a first thermoplastic polymer layer a) comprising a boundary surface with at least one functional group ra,
providing a second thermoplastic polymer layer b), said layer b) comprising a boundary surface with at least one functional group fb, equal to or different from said functional group ra,
applying a composition c) on the boundary surface of the first and/or second thermoplastic polymer layer, the composition comprising:
c1) a thermoplastic polymer with at least one functional group rc, equal to or different from said functional group ra) and/or rb), and
c2) a monomer or oligomer with at least two reactive functional groups rd1), rd2), such that rd1) = rd2), wherein rd1) and rd2) are selected for reactivity with the functional groups ra), rb) and rc),
reacting said at least two functional groups rd1), rd2) of the monomer or the oligomer with said functional groups ra), rb), rc), thereby cross-linking the boundary surface of the first layer a), the boundary surface of the second layer b) and the thermoplastic polymer c1); the thermoplastic polymer is a thermoplastic elastomer.

24. The method of manufacturing a composite element according to claim 23, wherein said first thermoplastic polymer layer a) is fibre-reinforced; the fibre reinforcement is selected from the group consisting glass fibres, aramid fibres, carbon fibres, basalt fibres, polyethylene fibres, polyester fibres, polyamide fibres, ceramic fibres, steel fibres, vegetable fibres, or combinations thereof.

25. The method of manufacturing a composite element according to claim 23, wherein said second thermoplastic polymer layer b) is selected from a foamed second thermoplastic polymer layer, a fibre-reinforced second thermoplastic polymer layer, a foamed and fibre-reinforced second thermoplastic polymer layer, a thermoplastic polymer layer with a honeycomb structure.

26. The method according to claim 23, wherein c1) the thermoplastic elastomer and c2) the monomer or oligomer are brought together less than 60 hours prior to the fabrication of the composite element.

27. The method according to claim 23, wherein before, during or after the application of said composition c), heating to a temperature between 30 and 120° C. is performed.

28. The method according to claim 23, wherein composition c) is applied in liquid form; wherein the liquid composition has a viscosity between 100 and 750 mPa.s.

29. The method according to claim 23, wherein composition c) is applied in the form of a powder or a film.

30. The method according to claim 23, wherein a pressure of at least 0.5 bar (50000 Pascal) and at most 5 bar (500000 Pascal) pressure is applied, following the application of composition c).

31. The method according to claim 23, wherein the monomer or oligomer is an epoxide, an aziridine, a carbodiimide, a polyisocyanate, a polyamine, a polyol, or an ethylene vinyl acetate.

32. The method according to claim 23, wherein the weight ratio of monomer or oligomer to thermoplastic elastomer is between 95:1 and 1:95, expressed with respect to the total weight of monomer or oligomer and thermoplastic elastomer.

33. The method according to claim 23, wherein the foamed thermoplastic polymer layer b) is a foamed polyester polymer layer including a polyethylene terephthalate foam or polyethylene furanoate foam layer.

34. The method according to claim 23, wherein said composition c) is applied to said boundary surface of the first thermoplastic polymer layer a), said composition c) is applied to said boundary surface of the second thermoplastic polymer layer b), both boundary surfaces are facing each other and layer a) and b) are brought together; wherein layer a) and b) are pressed together.

35. The method according to claim 23, wherein said composition c) is applied to said boundary surface of the first thermoplastic polymer layer a), and the second thermoplastic polymer layer b) is applied on top of said composition c).

36. The method according to claim 23, wherein
said composition c) is applied as follows:
said c2) monomer or oligomer is applied in liquid form on the boundary surface of the a) first and b) second thermoplastic polymer layer, c1) is supplied in the form of a film and is applied between a liquid c2) layer on the boundary surface of the a) first and b) second thermoplastic polymer layer.

37. The method according to claim 23, wherein one or both of the boundary surfaces of the a) first and/or b) second thermoplastic polymer layers are activated by a solvent treatment or plasma treatment before composition c) is used.

38. The method according to claim 23, wherein at least one functional group ra) and/or rb) is selected from an OH-group, an SH-group, an NH-group, an NH2-group, a carboxyl group.

39. The method according to claim 23, wherein a polyamide in layer a) is crosslinked with a polyester in layer b) and a thermoplastic polyurethane elastomer from composition c).

40. A composite element having improved resistance to delamination, the composite element comprising a first thermoplastic polymer layer a) and a second thermoplastic polymer layer b),
wherein a boundary surface of the first thermoplastic polymer layer a) is chemically crosslinked with a boundary surface of the second thermoplastic polymer layer b), by means of a composition c) comprising a thermoplastic elastomer and a monomer or oligomer for crosslinking a), b) and c), obtainable by a process according to claim 23.

41. The composite element having improved resistance to delamination according to claim 40, wherein said first thermoplastic polymer layer a) is fibre-reinforced by fibres selected from glass fibres, aramid fibres, carbon fibres, basalt fibres, polyethylene fibres, polyester fibres, polyamide fibres, ceramic fibres, steel fibres, vegetable fibres, or combinations thereof.

42. The composite element having improved resistance to delamination according to claim 40, wherein said second thermoplastic polymer layer b) is selected from a foamed second thermoplastic polymer layer, a fibre-reinforced second thermoplastic polymer layer, a foamed and fibre-reinforced second thermoplastic polymer layer, a thermoplastic polymer layer with a honeycomb structure.

43. The composite element according to claim 41, wherein the fibre-reinforced polymer layer a) is provided in the form of a fibre-reinforced polyamide or in the form of a layer with at least one unidirectional laminate.

44. Use of a composite element according to claim 40, as a wall in a transport vehicle, a wind turbine, a storage space, or a packaging container.
